(19) United States
(12) Patent Application Publication
(10) Pub. No.: US 2009/0177852 A1
(43) Pub. Date: Jul. 9, 2009

(54) DATA BLOCK RECEIVER AND METHOD FOR DECODING DATA BLOCK

(75) Inventors: Chien-yu Chen, Hsinchu City (TW); Yi-Hung Hsieh, Kaohsiung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/971,233

(22) Filed: Jan. 9, 2008

(51) Int. Cl. G06F 12/00

(52) U.S. Cl. 711/157; 711/E12.001

(57) ABSTRACT

A data block receiver for decoding a data block. The data block has a block sequence number (BSN). The data block receiver includes two de-interleavers, a memory circuitry, a combiner, a decoder, and an error detector. A first de-interleaver interleaves the data block to obtain a first de-interleaved data block. A stored data block with a BSN same with the data block is retrieved from the memory circuitry when the data block is not the newest data block. The second de-interleaver interleaves the retrieved data block to obtain a second de-interleaved data block. The second and the first de-interleaved data blocks are combined to form a combined data block. The decoder decodes the combined data block. The data block is stored when an error in the decoded data block is detected.

### BACKGROUND OF THE INVENTION

1. Field of the Invention

The invention relates to radio communications, and, more particularly, to techniques of decoding data blocks in a communication system.

Wireless telecommunication systems are well known in the art. In order to provide global connectivity for wireless systems, standards known as Global System for Mobile Telecommunications (GSM) have been developed. This is considered as a so-called Second Generation mobile radio system standard (2G) and was followed by its revision (2.5G). GPRS and EGPRS are examples of 2.5G technologies that offer relatively high speed data service on top of the (2G) GSM network. EGPRS can provide a data rate up to 384 kbps. In wireless communication, the signal may experience a multi-path channel. A signal passing through a multi-path channel has various amplitudes and phases, which decreases the rate of successful decoding. In a high speed data communication system like EGPRS, it is more difficult to decode the received data with an acceptably low error rate.

To guarantee data transmission quality in a wireless environment, some standards use the hybrid automatic repeat request (Hybrid-ARQ, or H-ARQ) scheme to prevent data loss or unsuccessful decoding. The hybrid-ARQ combines both ARQ (automatic repeat request) and FEC (forward error correction code) to achieve good data quality. The FEC uses convolution or turbo code to generate data in transmitter with more redundancy and can be correctly received by the receiver even if the wireless environment corrupts a portion of the received data. The ARQ is a scheme in which a receiver can continuously report data reception status to the transmitter and the transmitter can re-send data blocks lost by the receiver.

The hybrid ARQ combines both schemes and can further separate into type I H-ARQ, type II H-ARQ, and type III H-ARQ. Type I H-ARQ simply re-transmits the bad data packet and the receiver re-decodes the re-transmitted data packet. Both type II and III H-ARQs require large memory to store the previous unsuccessfully decoded data packet. The memory is usually called incremental redundancy (IR) memory. FIG. 1 shows an example of the conventional data packet decoder. As data packets are continuously transmitted, the number of data packets stored in the IR memory increases. Thus, the size of the IR memory is difficult to manage.

### BRIEF SUMMARY OF THE INVENTION

In one aspect of the invention, a data block receiver for decoding a data block is provided. The data block has a block sequence number (BSN) and consists of N bursts. The data block receiver comprises a first and second de-interleavers, a memory circuitry, a first and a second scale unit, a combiner, a decoder, and an error detector. The first de-interleaver performs an interleaving process for rearranging a data block and obtaining a first de-interleaved data blocks. The memory circuitry determines whether the data block is the newest received data block according to the block sequence number (BSN) corresponding to the data block. A stored data block with the same BSN is retrieved from the memory circuitry when the data block is not the newest data block. The first scale unit performs a first scale process on the retrieved data block. The second de-interleaver performs the interleaving process for rearranging the first scaled data block and obtains a second de-interleaved data block. The combiner combines the second de-interleaved data block and the first de-interleaved data block to obtain a combined data block. The decoder decodes the combined data block. The error detector detects whether an error exists in the decoded data block. The second scale unit performs a second scale process on the data block to obtain a second scaled data block. The second scale process is a process that reverts the first scale process. The second scaled data block is delivered to the memory circuitry when the error in the decoded data block is detected.

A method for decoding a data block is also provided. The data block comprises N bursts, and each burst further comprises a plurality of symbols. The method comprises de-interleaving the data block to obtain a de-interleaved data block. The de-interleaved data block is de-punctured to obtain a first de-punctured data block. The block sequence number (BSN) of the data block is examined to determine whether the data block is the newest received data block. A data block with the same BSN from a memory circuitry is retrieved when the BSN of the data block is not the newest data block. N scale factors are obtained, where each scale factor corresponds to a burst of the data block. A first scale process is performed on the retrieved data block to obtain a first scaled data block. The first de-interleaved data block is combined with the corresponding second de-interleaved data block to form the combined data block. The combined data block is then decoded. If any error is detected in the decoded data block, a second scaled data block is stored in the memory circuit. The second scale data block is formed by scaling the received data block by a second scale process.

### BRIEF DESCRIPTION OF THE DRAWINGS

The invention will become more fully understood from the detailed description, and the accompanying drawings. The drawings and description are provided for purposes of illustration only, and, thus, are not intended to be limiting of the invention.

FIG. 1 shows an example of the conventional data packet decoder;

FIG. 2 shows a block diagram of a data block receiver for decoding a data blocks according to an embodiment of the invention;

FIG. 3 shows a numerical example of the data block, the second scaled data block, and the first scaled data block;

FIG. 4 shows a numerical example of a data block and the limited data block;

FIG. 5 shows an example of the first de-punctured data block, the second de-punctured data block, and a combined data block;

FIG. 6 shows another block diagram of a data block receiver for decoding a data blocks according to an embodiment of the invention;

FIGS. 7a and 7b show a flowchart of a method for decoding a data block; and

FIGS. 7c and 7d show a flowchart of a method for decoding a data block.

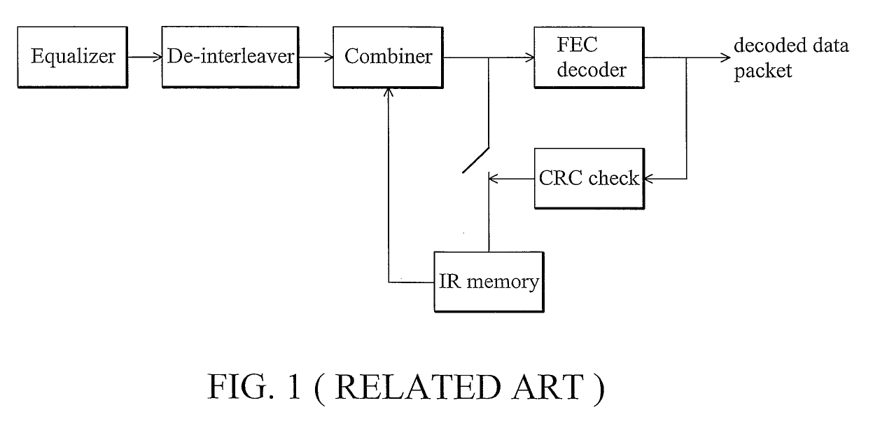

### DETAILED DESCRIPTION OF THE INVENTION

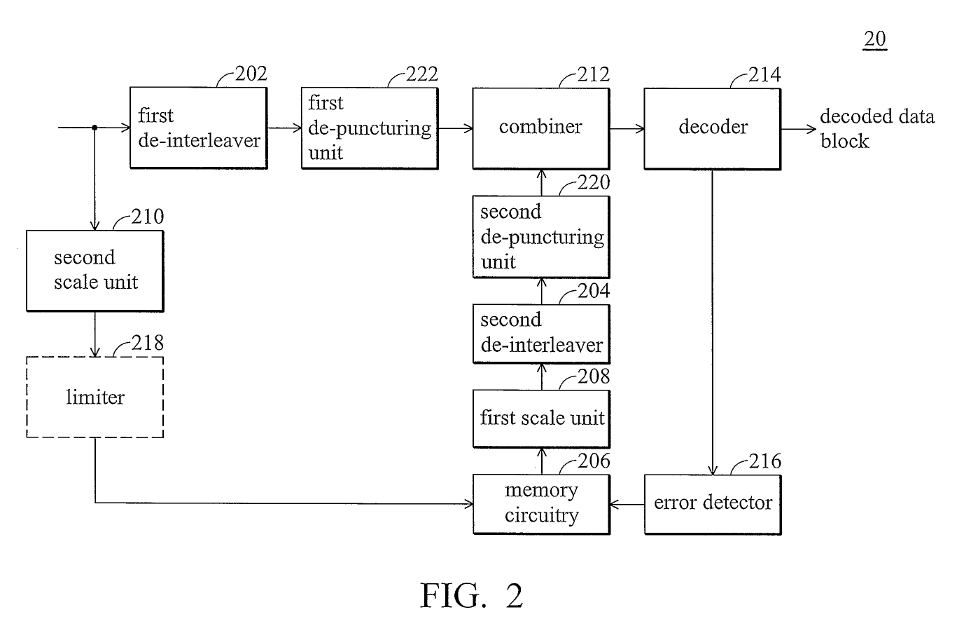

FIG. 2 shows a block diagram of a data block receiver for decoding a data blocks according to an embodiment of the invention. The data block has a block sequence number (BSN) and consists of N bursts. The data block receiver comprises a first de-interleaver 202 and a second de-interleaver 204, a memory circuitry 206, a first scale unit 208 and a second scale unit 210, a combiner 212, a decoder 214, an error detector 216, a first de-puncturing unit 222 and a second de-puncturing unit 220, and a limiter 218. The first de-interleaver 202 performs an interleaving process for rearranging a data block and obtaining a first de-interleaved data block. The memory circuitry 206 determines whether the data block is the newest received data block according to the block sequence number (BSN) corresponding to the data block. For example, the newest received data block is the data block with a BSN not received before. In addition, the BSN of the newest received data block does not need to be the largest BSN being received. Sometimes, it is possible that one BSN is not correctly decoded so that even the associated data block of the BSN is received, the BSN may still be defined as the newest received BSN when later the associated data block is retransmitted and received. In other words, a data block with the BSN that is not stored in the memory is determined to be the newest data block. A stored data block with the same BSN is retrieved from the memory circuitry 206 when the data block is not the newest data block. The first scale unit 208 performs a first scale process on the retrieved data block. In one embodiment, the first scale process multiplies a scale factor on each symbol of the data block, where the scale factor is a value exceeding one. Since the N bursts in one data block may suffer from different forms of interference and have different signal levels, in some embodiments the first scale process comprises obtaining N scale factors corresponding to N bursts, and multiplying each burst with a scale factor corresponding to that burst. The second de-interleaver 204 performs the interleaving process for rearranging the first scaled data block and obtains a second de-interleaved data block. The combiner 212 combines the second de-interleaved data block and the first de-interleaved data block to obtain a combined data block. The decoder 216 decodes the combined data block. The error detector 216 detects whether an error exists in the decoded data block. The second scale unit 210 performs a second scale process on the data block to obtain a second scaled data block. The second scale process is a process that reverts the first scale process. The second scaled data block is delivered to the memory circuitry 206 when the error in the decoded data block is detected.

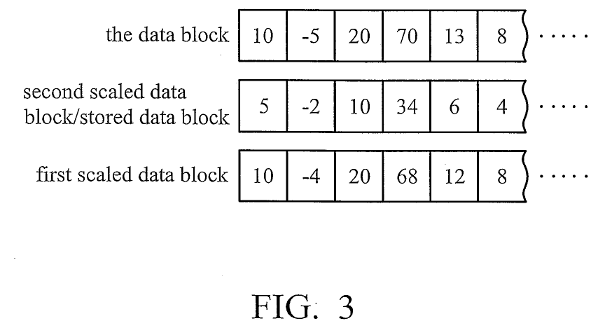

The second scale process can compress the dynamic range of the stored data, thus the bit-width of the memory circuitry is reduced. In some embodiments, such as the hybrid ARQ data block receiver, the feature makes managing the memory circuitry easier. The second scaled data block is recovered from the received data block. FIG. 3 shows a numerical example of the data block, the second scaled data block, and the first scaled data block. In the example, the symbols of the second scaled data dividing the symbol of the data block by 2, and take only the integer part. The symbols of the first scaled data are the symbols of the stored data block multiplied by 2, thus the symbols of the first scaled data block may differ slightly from the data block.

The memory circuitry, in some embodiments, further records the number of stored data blocks, and discards the oldest data block when the number of stored data blocks exceeds a predetermined data block number.

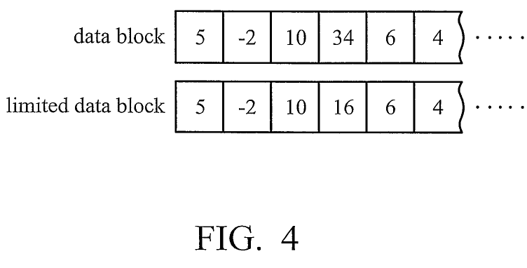

In some embodiments, the data block receiver further comprises a limiter 218. The limiter, coupling to the second scale unit 210, limits signal levels of the scaled data block to a predetermined signal level. The memory circuitry 206 in the embodiment stores the limited data block instead of the scaled data block to further decrease the bit-width of the memory circuitry. FIG. 4 shows a numerical example of a data block and the limited data block. In this embodiment, the predetermined signal level is ±16, thus any symbols exceeding 16, or below −16, are rounded to ±16.

The error detector 216 can a CRC check, and the decoder may vary, depending on which coding scheme the data block is encoded by. For example, the decoder may be a convolutional decoder or a turbo decoder.

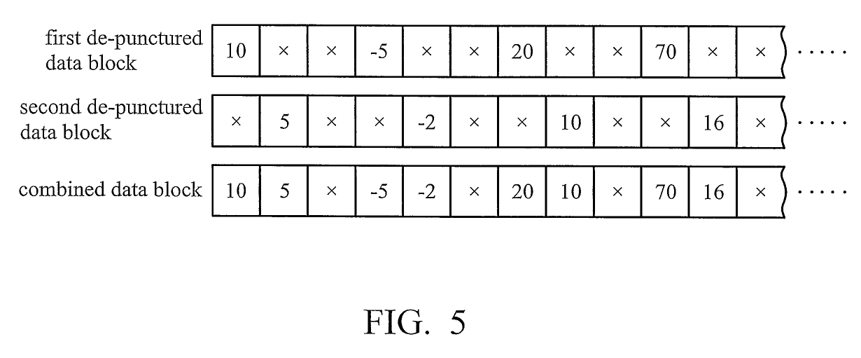

In some embodiments, the data block is punctured before being transmitted. Thus, the data block receiver further comprises a first and a second de-puncturing unit 222 and 220 to recover the puncturing. The first and the second de-puncturing units 222 and 220 de-puncture the first interleaved data block and the second de-interleaved data block respectively to obtain a first de-punctured data block and a second de-punctured data block. The combiner 212 combines portions of the first de-punctured data block with corresponding portions of the second de-punctured data block. FIG. 5 shows an example of the first de-punctured data block, the second de-punctured data block, and a combined data block. In the example, “x” stands for a punctured symbol, and the combined data block has less punctured symbols than the first and second de-punctured data blocks.

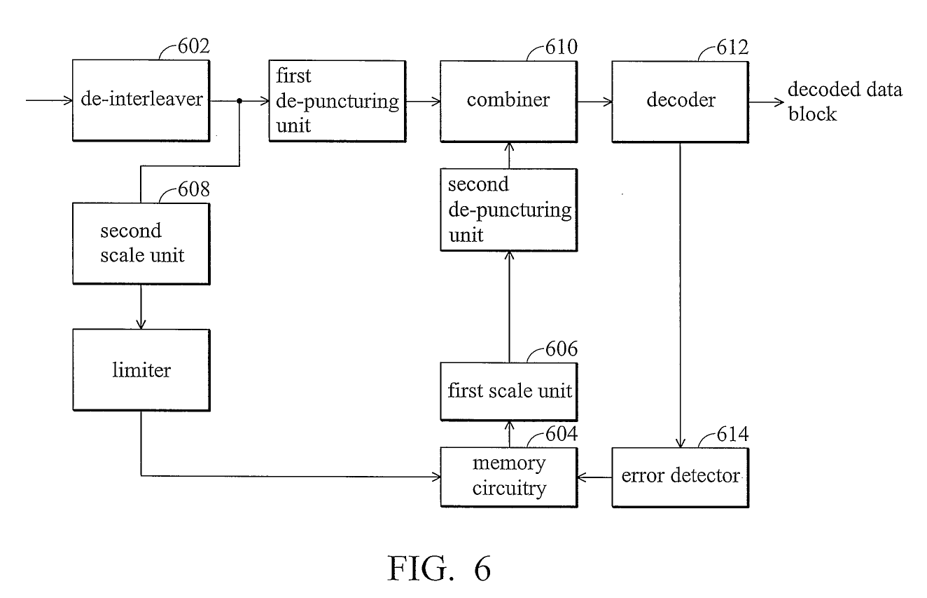

In other embodiments, the data block is stored after de-interleaving, thus only one de-interleaver is required. FIG. 6 shows another block diagram of a data block receiver for decoding a data blocks according to an embodiment of the invention. The data block has a block sequence number (BSN) and consists of N bursts. The data block receiver comprises a de-interleaver 602, a memory circuitry 604, a first and a second scale unit 606 and 608, a combiner 610, a decoder 612, and an error detector 614. The de-interleaver 602 performs an interleaving process for rearranging a data block and obtaining a first de-interleaved data blocks. The memory circuitry 604 determines whether the data block is the newest received data block according to the block sequence number (BSN) corresponding to the data block. For example, the newest received data block is the data block with this BSN not received before. In other words, a data block having the BSN that has never been stored in the memory is determined to be the newest data block. A stored data block with the same BSN is retrieved from the memory circuitry 604 when the data block is not the newest data block. The first scale unit 606 performs a first scale process on the retrieved data block. In one embodiment, the first scale process, multiplies a scale factor on each symbol of the data block, where the scale factor is a value exceeding one. Because the N bursts in one data block may suffer from different forms of interference and have different signal levels, some embodiments of the scale process comprises obtaining N scale factors corresponding to N bursts, and each burst is multiplied with a scale factor corresponding to that burst. The combiner 610 combines the de-interleaved data block and the first scaled data block to obtain a combined data block. The decoder 612 decodes the combined data block. The error detector 614 detects whether an error exists in the decoded data block. The second scale unit 608 performs a second scale process on the data block to obtain a second scaled data block. The second scale process is a process that reverting the first scale process. For example, the second scale process may comprise dividing symbols of the data block with a corresponding scale factor. The second scale process narrows the dynamic range of the data block, so that the bit-length of the memory circuitry is easy to manage. The second scaled data block is delivered to the memory circuitry 604 when the error in the decoded data block is detected.

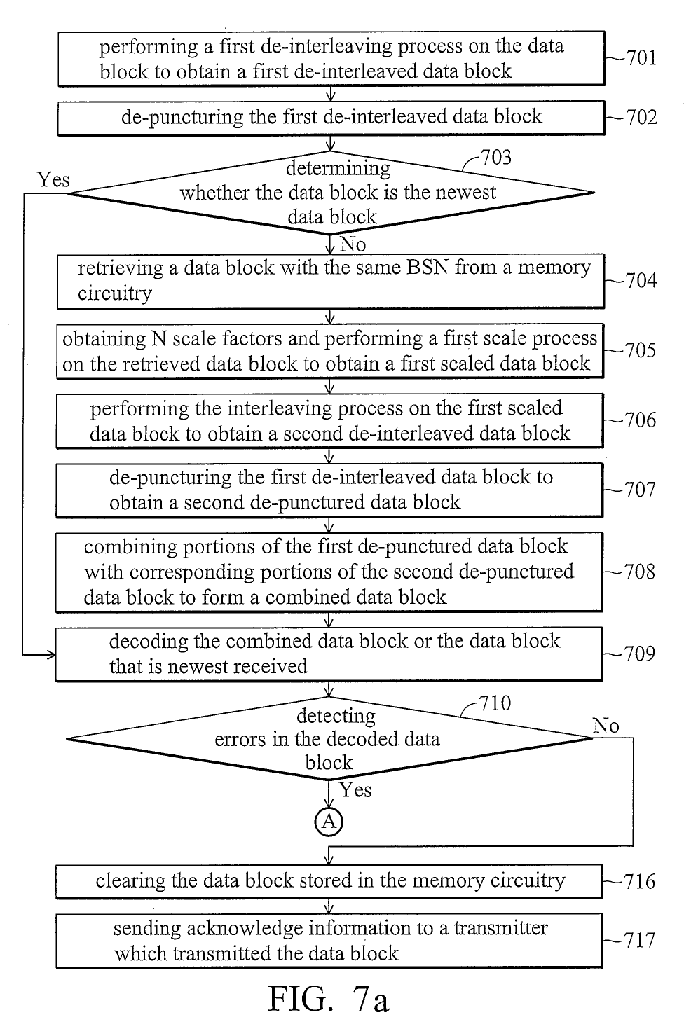

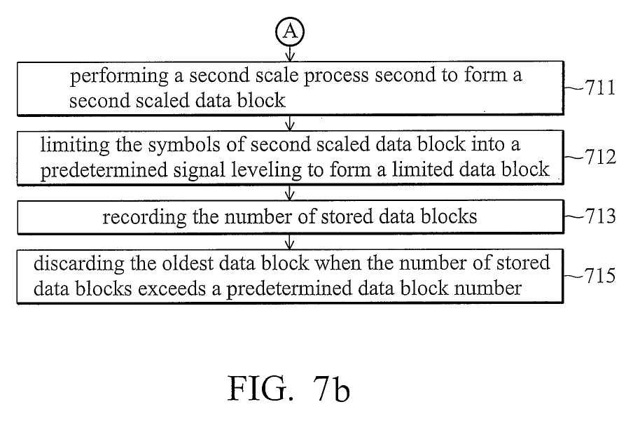

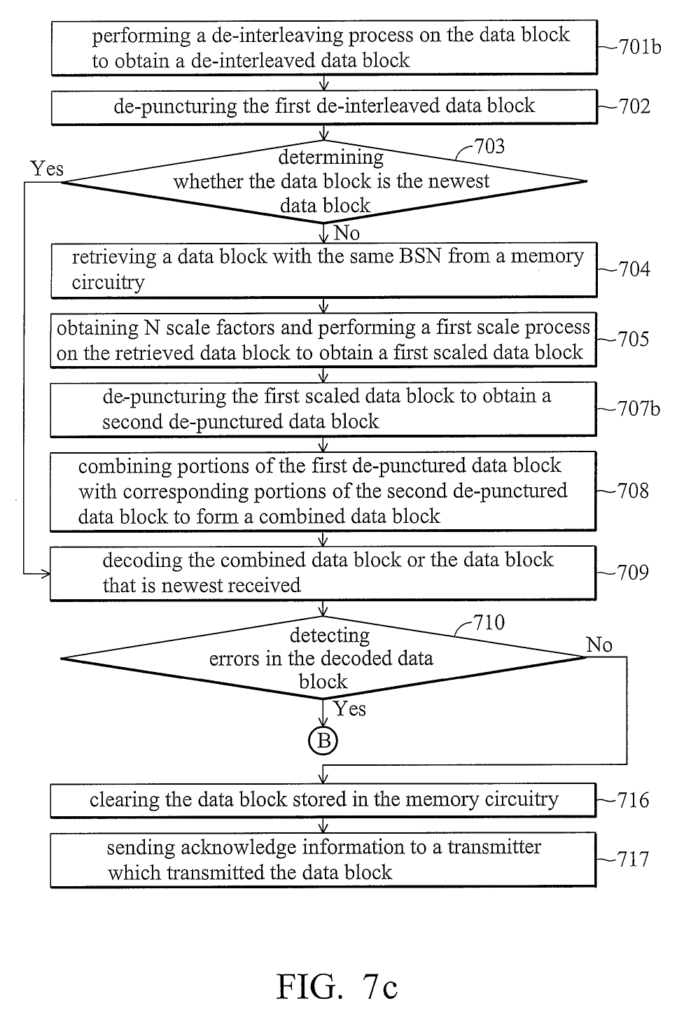

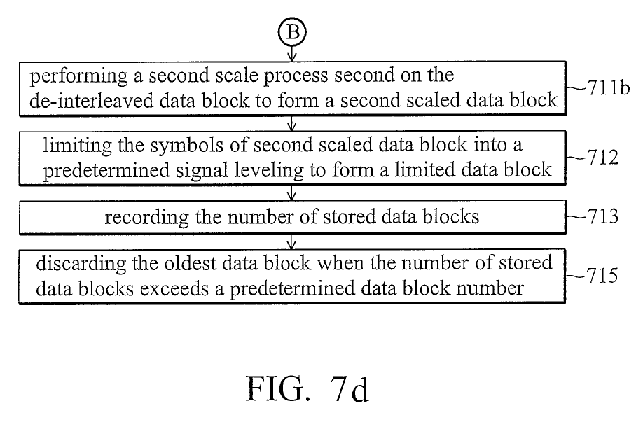

FIGS. 7a and 7b show a flowchart of a method for decoding a data block, wherein a data block, comprising N bursts, is punctured before transmitting, and each burst further comprises a plurality of symbols. The method comprises de-interleaving the data block according to a first de-interleaving process to obtain a de-interleaved data block in step 701. The de-interleaved data block is de-punctured to obtain a first de-punctured data block. In step 702, the block sequence number (BSN) of the data block is examined to determine whether the data block is the newest received data block. When the BSN of the data block is not the newest data block, a previous received data block with the same BSN is obtained in step 704-708. If the data block is the newest received data block, step 704-708 is skipped. In step 704, a data block with the same BSN from a memory circuitry is retrieved. N scale factors are obtained in step 705, where each scale factor corresponds to a burst of the data block. A first scale process is performed on the retrieved data block to obtain a first scaled data block. In step 706, the first scaled data block is de-interleaved to obtain a second de-interleaved data block. In step 707, the first de-interleaved data block is de-punctured to obtain a second de-punctured data block. Portions of the first de-punctured data block are combined with corresponding portions of the second de-punctured data block to form the combined data block in step 708. The combined data block or the newest received data block is decoded in step 709. In step 710, the decoded data block is detected to check if any error exists in the decoded data block. If any error is detected in the decoded data block, a limited data block is stored in the memory circuit in step 712. Limiting the symbols of the second scaled data block into a predetermined signal level forms the limited data block. The second scale data block is formed in step 711 by scaling the data block with a second scale process. The second scale process is a reverse process of the first scale process. For example, if the first scale process comprises multiplying a multiplicand with a scale factor, the second scale process may comprises dividing the first scaled result with the scale factor. In step 713, the number of stored data blocks is recorded. If the number of stored data blocks exceeds a predetermined data block number, the oldest data block is discarded in step 715. If no error is detected in the decoded data block in step 710, the data block stored in the memory circuitry is cleared in step 716, and acknowledgement is sent to the transmitter that originally transmitted the data block in step 717.

In another embodiment of the invention, the stored data block is de-interleaved. Thus, retrieving this data block can eliminate a de-interleaving process. The scale process, however, requires modification. FIGS. 7c and 7d show a flowchart of a method for decoding a data block, wherein a data block, comprising N bursts, is punctured before transmission, and each burst further comprises a plurality of symbols. The method comprises de-interleaving the data block to obtain a de-interleaved data block in step 701b. The de-interleaved data block is de-punctured in step 702 to obtain a first de-punctured data block. In step 703, the block sequence number (BSN) of the data block is examined to determine whether the data block is the newest received data block. When the BSN of the data block is not the newest data block, a previous received data block with the same BSN is obtained in steps 704-709. If the data block is the newest received data block, steps 704-709 are skipped. In step 704, a data block with the same BSN from a memory circuitry is retrieved. N scale factors are obtained in step 705, where each scale factor corresponds to a burst of the data block. A first scale process is performed in step 705 on the retrieved data block in step 704 to obtain a first scaled data block. In this embodiment, the first scale process comprises: a) determining from which burst a symbol comes; b) re-scaling the symbol with a scale factor corresponding to the determined burst; and c) repeating steps a) and b) until all the symbols in the data block are re-scaled. In step 707b, the first scaled data block is de-punctured to obtain a second de-punctured data block. Portions of the first de-punctured data block are combined with corresponding portions of the second de-punctured data block to form the combined data block in step 708. The combined data block or the newest received data block is decoded in step 709. In step 710, the decoded data block is detected to determine if any error exists in the decoded data block. If any error is detected in the decoded data block, a limited data block is stored in the memory circuit in step 715. The limited data block is formed by limiting the symbols of the second scaled data block in step 712 to a predetermined signal level. The second scale data block is formed by scaling the de-interleaved data block by a second scale process in step 711b. The second scale process is a reverse process of the first scale process. For example, if the first scale process comprises multiplying a multiplicand with a scale factor, the second scale process may comprise dividing the first scaled result by the scale factor. In step 713, the number of stored data blocks is recorded. If the number of stored data blocks exceeds a predetermined data block number, the oldest data block is discarded. If no error is detected in the decoded data block in step 710, the data block stored in the memory circuitry is cleared in step 716, and acknowledgement is sent in step 717 to the transmitter that originally transmitted the data block.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data block receiver for decoding a data block, comprising:
a first de-interleaver performing a interleaving process for rearranging the data block and obtaining a first de-interleaved data blocks;
a memory circuitry determining whether the data block is the newest received data block according to a block sequence number (BSN) corresponding to the data block, and retrieving a stored data block with the same BSN from the memory circuitry when the data block is not the newest data block;
a first scale unit performing a first scale process on the stored data block to obtain a first scaled data block;
a second de-interleaver performing the interleaving process for rearranging the first scaled data block and obtaining a second de-interleaved data block;
a combiner combining the second de-interleaved data block and the first de-interleaved data blocks to obtain a combined data block;
a decoder decoding the combined data block;
an error detector detecting whether an error exists in the decoded data block; and
a second scale unit performing a second scale process on the data block to obtain a scaled data block and delivering the scaled data block to the memory circuitry, wherein the second scale process is a reverse process of the first scale process.

2. The data block receiver as claimed in claim 1, wherein the second scaled data block has a plurality of symbols, and the data block receiver further comprises:
a limiter, coupled to the second scale unit, limiting signal levels of the plurality of symbols to a predetermined signal level;
wherein the memory circuitry storing the limited data block instead of the second scaled data block when the error of the decoded data block is detected.

3. The data block receiver as claimed in claim 1, wherein the data block comprises N bursts, the second scale unit obtains N scale factors of the data block, and the second scale process comprises multiplying each burst of the first de-interleaved data block with a scale factor corresponding to the burst.

4. The data block receiver as claimed in claim 3, wherein the stored data block comprises N bursts, the first scale unit obtains the N scale factors of the data block, and the first scale process comprises dividing each burst of the stored data block by a scale factor corresponding to the burst.

5. The data block receiver as claimed in claim 1, wherein the memory circuitry records the number of stored data blocks, and discards the oldest data block when the number of stored data blocks exceeds a predetermined data block number.

6. The data block receiver as claimed in claim 1, wherein the data block are punctured before being transmitted, and the data block receiver further comprises:
a first de-puncturing unit de-puncturing the first de-interleaved data block to obtain a first de-punctured data block; and
a second de-puncturing unit de-puncturing the second de-interleaved data block to obtain a second de-punctured data block;
wherein the combiner combines portions of the first de-punctured data block with corresponding portions of the second de-punctured data block.

7. A data block receiver for decoding a data block, comprising:
a de-interleaver performing a interleaving process for rearranging the data block and obtaining a de-interleaved data blocks;
a memory circuitry determining whether the data block is the newest received data block according to a block sequence number (BSN) corresponding to the data block, and retrieving a stored data block with the same BSN from the memory circuitry when the data block is not the newest data block;
a first scale unit performing a first scale process on the stored data block to obtain a first scaled data block;
a combiner combining the second de-interleaved data block and the first de-interleaved data blocks to obtain a combined data block;
a decoder decoding the combined data block;
a error detector detecting whether an error exists in the decoded data block; and
a second scale unit performing a second scale process on the de-interleaved data block to obtain a second scaled data block and delivering the second scaled data block to the memory circuitry, wherein the second scale process is a reverse process of the first scale process.

8. The data block receiver as claimed in claim 7, wherein the second scaled data block has a plurality of symbols, and the data block receiver further comprises:
a limiter, coupled to the second scale unit, limiting the signal levels of the plurality of symbols to a predetermined signal level;
wherein the memory circuitry storing the limited data block instead of the second scaled data block when the error of the decoded data block is detected.

9. The data block receiver as claimed in claim 7, wherein the data block comprises N bursts, each symbol corresponds to one burst, and the second scale process comprises determining which burst a symbol comes from, and dividing the symbol with a scale factor corresponding to the determined burst.

10. The data block receiver as claimed in claim 9, wherein the stored data block comprises N bursts, the first scale unit obtains the N scale factors of the data block, and the first scale process comprises determining which burst a symbol comes from, and multiplying each burst of the stored data block with a scale factor corresponding to the burst.

11. The data block receiver as claimed in claim 7, wherein the memory circuitry records the number of stored data blocks, and discards the oldest data block when the number of stored data blocks exceeds a predetermined data block number.

12. The data block receiver as claimed in claim 7, wherein data blocks are punctured before being transmitted, and the data block receiver further comprises:
a first de-puncturing unit de-puncturing the de-interleaved data block to obtain a first de-punctured data block; and
a second de-puncturing unit de-puncturing the first scaled data block to obtain a second de-punctured data block;
wherein the combiner combines portions of the first de-punctured data block with corresponding portions of the second de-punctured data block.

13. A method for decoding a data block, wherein the data block comprises N bursts, and the method comprises:
performing a interleaving process for rearranging the data block and obtaining a de-interleaved data blocks;
determining whether the data block is the newest received data block according to a block sequence number (BSN) corresponding to the data block;
obtaining a combined data block when the data block is not the newest data block, comprising:
retrieving a data block with the same BSN from a memory circuitry;
obtaining N scale factors, wherein each scale factor corresponds to a burst of the data block;
performing a first scale process on the retrieved data block to obtain a first scaled data block; and
combining the first scaled data block and the de-interleaved data blocks to obtain the combined data block;
decoding the combined data block;
detecting whether an error exists in the decoded data block; and
storing a second scaled data block into the memory circuitry when the error is detected in the decoded data block, wherein the second scaled data block is scaling the decoded data block with a second scale process and the second scale process is a reverse process of the first scale process.

14. The method as claimed in claim 13, wherein the second scaled data block has a plurality of symbols, and the method further comprises:
limiting signal levels of the plurality of the symbols to a predetermined signal level; and
storing the limited data block instead of the second scaled data block when the error of the data block is detected.

15. The method as claimed in claim 13, wherein the retrieved data block has a plurality of symbols, each symbol corresponds to one burst, and the first scale process further comprises:
a) determining which burst a symbol comes from;
b) multiplying the symbol with a scale factor corresponding to the determined burst; and
c) repeating step a) and b) until all the symbols in the retrieved data block are scaled.

16. The method as claimed in claim 15, wherein the de-interleaved data block has a plurality of symbols, each symbol corresponds to one burst, and the second scale process further comprises:
a) determining from which burst a symbol comes;
b) multiplying the symbol by a scale factor corresponding to the determined burst; and
c) repeating step a) and b) until all the symbols in the de-interleaved data block are scaled.

17. The method as claimed in claim 13 further comprising:
recording the number of stored data blocks; and
discarding the oldest data block when the number of stored data blocks exceeds a predetermined number of data blocks.

18. The method as claimed in claim 13, wherein the data block is punctured before being transmitted, and the method further comprises:
de-puncturing the de-interleaved data block to obtain a first de-punctured data block; and
de-puncturing the second scaled data block to obtain a second de-punctured data block;
wherein the combining steps further comprises combining portions of the first de-punctured data block with corresponding portions of the second de-punctured data block.

19. The method as claimed in claim 13, further comprising:
decoding the data block when the data block is the newest received data block; and
detecting whether an error exists in the decoded data block.

20. The method as claimed in claim 13, further comprising:
clearing the data block stored in the memory circuitry when no error is detected in the decoded data block, wherein the cleared data block has a BSN the same as the BSN of the data block; and
sending a acknowledge information to a transmitter which transmitted the data block.

21. The method as claimed in claim 13, wherein the de-interleaved data block is a first de-interleaved data block, and the method further comprising:
performing the interleaving process for rearranging the first scaled data block and obtaining a second de-interleaved data blocks; and
combining the second de-interleaved data block with the first de-interleaved data block to obtain the combined data block instead of combining the first scaled data block and the de-interleaved data blocks to obtain the combined data block.

22. The method as claimed in claim 21, wherein the data block is punctured before being transmitted, and the method further comprises:
de-puncturing the de-interleaved data block to obtain a first de-punctured data block; and
de-puncturing the second de-interleaved data block to obtain a second de-punctured data block;
wherein the combining steps further comprises combining portions of the first de-punctured data block with corresponding portions of the second de-punctured data block.
